(19) United States
(12) Patent Application Publication
(10) Pub. No.: US 2005/0164888 A1
(43) Pub. Date: Jul. 28, 2005

(54) Systems and methods for signal filtering

(76) Inventor: Gregory Lynton Hey-Shipton, Santa Barbara, CA (US)

Correspondence Address: Wolff Law Offices, PLLC;Suite 402, 2111 Eisenhower Ave., Alexandria, VA, 22314, US

(21) Appl. No.: 11/083,218

(22) Filed: Mar. 18, 2005

Related U.S. Application Data
(63) Continuation-in-part of application No. 10/430,914, filed on May 6, 2003.
Application No. 10/430,914 is a continuation of application No. 09/818,100, filed on Mar. 26, 2001, now Pat. No. 6,686,811.

(51) Int. Cl. H01P 1/00

(52) U.S. Cl. 505/210

(57) ABSTRACT

Systems and methods for communication system having improved transmitter and/or receiver performance. The invention may include systems and methods related to the use of non-superconducting and/or superconducting filters for a receiver and/or a transmitter. The invention is particularly useful in electronic communication systems that have heavy usage and requiring accurate and sharp channel filtering, for example wireless communication systems. In various embodiments, a receive filter network may include a non-superconducting filter and/or a superconducting filter. In various embodiments, a transmit filter network may include a non-superconducting filter and/or a superconducting filter. The superconducting filter(s) may be, for example, a band pass filter and/or a notch filter or band reject filter.

### CROSS-REFERENCE TO RELATED APPLICATIONS

This application is a continuation-in-part of co-pending U.S. application Ser. No. 10/430,914, filed May 6, 2003, which is a continuation of co-pending U.S. application Ser. No. 09/818,100, filed Mar. 26, 2001, and now issued as U.S. Pat. No. 6,686,811, which are fully and expressly incorporated herein by reference.

### BACKGROUND OF THE INVENTION

1. Field of the Invention

The present invention relates to the field of communications and, more specifically, to methods and systems for providing, at least in part, electronic communications.

2. Description of the Related Art

Today there are numerous types of electronic or electronic assisted communication systems that include, for example, radio, television, cable, internet, two-way radio, cellular telephone systems, LANS, WANS, and optical communication systems. Many of these systems may employ various types of signal amplifiers and filters in their receivers and/or transmitters that have a particular performance capability to support today's use and traffic requirements. However, these electronic communication systems will likely experience increased communication information use and traffic in the future that will require better signal amplifiers and filters beyond their present capability and the systems would thus benefit from incorporating system designs and components that provides better filtering and amplification characteristics to accommodate the additional use and traffic.

For example, at the receiver side signal amplifiers are used at the receiver front end to boost received signal so as to provide cost effective and reliable received signals. This approach improves overall receiver sensitivity and radio link margin. In addition, it is often advantageous to use signal filtering at the receiver front end to improve channel selectivity and noise rejection, suppress cross channel interference, and maintain a high sensitivity even in the presence of out of band interference. In many applications a standard low noise amplifier (LNA) and conventional filter, for example a band pass filter, may be sufficient. However, in the presence of electromagnetic interference, low noise conventional products may not provide sufficient filtering to protect the noise floor of the base station from increasing. In such cases, the conventional receiver front end systems must be replaced with better performance systems such as, for example, an High Temperature Superconductor (HTS) based system that may include an HTS band pass filter, that provides greater sensitivity, greater selectivity, or a combination thereof.

On the transmitter side, signal amplifiers and filters may also be used. In order for the noise spectrum from cellular (or similar telecommunication) transmitters to be attenuated to an acceptable level, the transmit filters need to have high rejection close to the pass band edge. This enables the out-of-band noise power from the transmit power amplifiers to be attenuated sufficiently, thereby simplifying the power amplifier design. In addition, the transmit filters need to have low insertion loss for efficient operation so as not to lose transmitter power.

For the receiver, highly selective, very low loss band pass filters have been made from HTS, and excellent performance is commercially available from such devices (e.g. SuperLink from Superconductor Technologies Inc.). On the other hand, for transmitter band pass filters, the resonant frequency of the resonators in the operating band of the transmitter and stored energy in the resonators can cause non-linear effect. This is particularly true for HTS filters used on the transmit side because of non-linearity in the HTS films. Some resonator structures have been developed that reduces this non-linear effect, but their practicality and cost for transmit applications has limited their acceptance.

Therefore, there is a need to offer alternative ways to provide improved filtering of receivers (e.g. SuperLink from Superconductor Technologies Inc.). Further, there is a need to improve the performance and rejection characteristics of the transmitter filtering with a practical and reasonable cost solution.

### SUMMARY

The present invention is directed generally to providing systems and methods for communication system having improved transmitter and/or receiver performance. The invention may include systems and methods related to the use of non-superconducting and/or superconducting filters for a receiver and/or a transmitter. The invention is particularly useful in electronic communication systems that have heavy usage and requiring accurate and sharp channel filtering, for example wireless communication systems.

In various embodiments, a receive filter network may include a non-superconducting filter and/or a superconducting filter. The output of the non-superconducting filter may be coupled to an input of a superconducting filter. The non-superconducting filter may pre-filter received RF signals by passing RF signals having a frequency within a first pass band to the superconducting filter. The superconducting filter may further filter the RF signals to provide a high degree of frequency selectivity at its output. The receive filter network of the present invention may provide high frequency selectivity while overcoming many of the disadvantages associated with superconducting filters. This may be achieved by, for example, pre-filtering the RF signals with the non-superconducting filter before inputting them to the superconducting filter. The receive superconducting filter may be a band pass filter and/or a notch filter or band reject filter. The non-superconducting filter may protect the superconducting filter from lightning surges or other high power signals. In addition, the non-superconducting filter may filter out interferers that produce in-band intermodulation spurious signals output from the superconducting filter. In a multiplexed configuration, the receiver non-superconducting filter may protect the superconducting filter directly from transmit signal energy.

In various embodiments, a transmit filter network may include a non-superconducting filter and/or a superconducting filter. The use of superconducting filters, for example HTS filter structures, that may be resonant outside of the transmitter operating band may give very sharp rejection to signal energy in the region close to the operating frequency band. This may be couple to a conventional band pass filter, and/or the transmit portion of a duplexer or multiplexer, to provide a transmit filter network with excellent out of band noise rejection. The use of a notch filter that includes, for example superconducting resonators, to form a very sharp notch filter may enhance the rejection characteristics of a conventional band pass filter. The superconducting resonators may be HTS. The close to operating band rejection may be dominated by the notch filter and the far away from operating band may be dominated by the band pass filter. Stored energy in the HTS notch filter may be mainly out of the operating band enabling HTS structures with lower power handling. Multiple notches may be used to generate an apparent very sharp band pass response with very low pass band losses. This may enable the design of power amplifiers (for which the filters are needed to reduce out-of-band noise power) to be simplified.

### BRIEF DESCRIPTION OF THE DRAWINGS

The utility, objects, features and advantages of the invention will be readily appreciated and understood from consideration of the following detailed description of the embodiments of this invention, when taken with the accompanying drawings, in which same numbered elements are identical and:

FIG. 1 shows a communications system incorporating a filter network, according to one exemplary embodiment of the invention;

FIG. 2A shows a top view of a non-superconducting filter, according to one exemplary embodiment of the present invention;

FIG. 2B shows a cross-sectional side view of the non-superconducting filter, according to one exemplary embodiment of the present invention;

FIG. 3 shows a plot of the filter response of the non-superconducting filter, according to one exemplary embodiment of the present invention;

FIG. 4 shows a multiplexer, according to one embodiment of the present invention;

FIG. 5 shows a double-duplexer, according to one exemplary embodiment of the present invention;

FIG. 6 shows a double-duplexer, according to one exemplary embodiment of the present invention;

FIG. 7 is shows a transmit network, according to at least one exemplary embodiment;

FIG. 8 shows a transmit network, according to at least one exemplary embodiment;

FIG. 9 shows a multiplexer, according to one embodiment of the present invention;

FIG. 10 shows a double-duplexer, according to one exemplary embodiment of the present invention;

FIGS. 11A and 11B show block diagrams for transmit filter structures, according to one exemplary embodiment of the present invention;

FIGS. 12A and 12B show various insertion loss graphs for the transmit filter structures illustrated in FIGS. 11A and 11B, according to one exemplary embodiment of the present invention;

FIGS. 13A and 13B show various performance characteristics for the transmit filter structure illustrated in FIG. 11B, according to one exemplary embodiment of the present invention;

FIGS. 14A and 14B show various graphs for low loss of the transmit filter structure illustrated in FIG. 11B, according to one exemplary embodiment of the present invention;

FIG. 15 shows a circuit schematic of cascaded filters, according to one exemplary embodiment of the present invention;

FIG. 16 shows a block diagram for a filter network including one superconductor filter, according to one exemplary embodiment of the present invention;

FIG. 17 shows a block diagram for a filter network including two superconductor filters on either side of a non-superconductor, according to one exemplary embodiment of the present invention;

FIG. 18 shows a block diagram for a filter network including two superconductor filters coupled together and to a non-superconductor filter, according to one exemplary embodiment of the present invention;

FIG. 19 shows a configuration including a combination of receive filters and transmit filters within the same cooler, according to one exemplary embodiment of the present invention; and

FIG. 20 shows a configuration including a combination of receive filters and transmit filters within the same cooler, according to one exemplary embodiment of the present invention.

### DESCRIPTION OF THE PREFERRED EMBODIMENTS

In general, the present invention is directed generally to providing systems and methods for designing an electronic communication system having improved signal filtering that may include, for example, one or more receiver(s), transmitter(s), and/or transceiver(s) having one or more signal amplifier(s) and/or signal filter(s). More particularly, the present invention is believed to be applicable to a variety of radio frequency (RF) applications in which achieving low insertion loss in the pass band with high attenuation in the stop band, and an extremely high degree of selectivity in the pass band are necessary. The present invention is particularly applicable and beneficial for cellular-communication base stations, and other communication applications. While the present invention is not so limited, an appreciation of the present invention is best presented by way of a particular example application, in this instance, in the context of such a communication system.

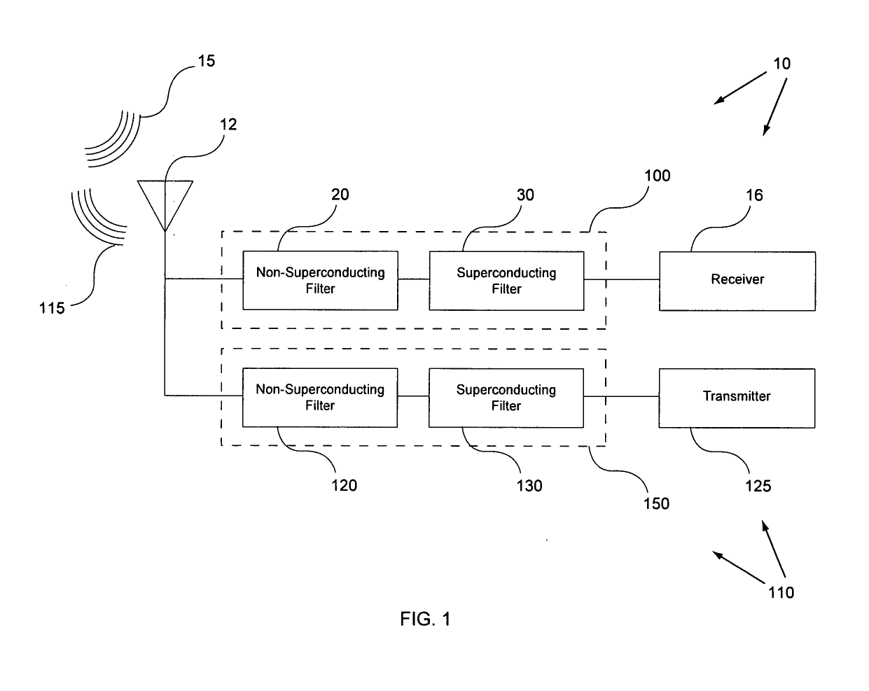

Now turning to the drawings, FIG. 1 shows a front-end receiver system 10 and a transmit system 110 of, for example, a base station, according to a particular application and embodiment of the present invention. The front-end receiver system 10 includes an antenna 12 for receiving RF signals 15, a filter network 100 for filtering the received RF signals, and a receiver 16. The filter network 100 is used to selectively pass received RF signals within a designated pass band to the receiver 16, while filtering out interferers. The interferers are interfering signals located outside the operating frequency of the receiver 16, and include RF signals transmitted by other cellular service providers. The interferers also include co-located transmission signals transmitted by the transmitter side of the same base station.

The filter network 100 comprises a non-superconducting filter 20 and a superconducting filter 30, preferable a High Temperature Superconducting (HTS) filter. The input of the non-superconducting filter 20 receives RF signals 15 from the antenna 12. The output of the non-superconducting filter 20 is coupled to the input of the superconducting filter 30, and the output of the superconducting filter is coupled to the receiver 16. The non-superconducting filter 20 pre-filters the received RF signals 15 before they are filtered by the superconducting filter 30.

The non-superconducting filter 20 is a bandpass filter tuned to pass the received RF signals having a frequency first pass band equal to, or greater than, the superconducting filter 30 frequency pass band. Preferably, the first pass band encompasses a receiving frequency range of the base station. For base stations using the Advanced Mobile Phone Service (AMPS) standard, for example, the total receiving frequency range is approximately 824 MHz to 849 MHz. The superconducting filter 30 is a bandpass filter tuned to pass the pre-filtered RF signals having a frequency within a second pass band to the receiver 16. The second pass band is a narrow pass band located inside the first pass band for providing high frequency selectivity to the receiver 16.

The non-superconducting filter 20 protects the superconducting filter 30 from high power out-of-band signals that can cause catastrophic failure of the superconducting filter 30. The high power signals include electrical surges caused by lightning strikes. In addition, the non-superconducting 20 filter filters out interferers located outside the first pass band before they are inputted to the superconducting filter 30. This is done because these interferers produce in-band intermodulation spurious signals in the superconducting filter 30. By filtering out these interferers before they are inputted to the superconducting filter 30, the non-superconducting filter 20 may dramatically reduce the in-band intermodulation spurious signals.

The superconducting filter 30 provides sharp frequency selectivity to the receiver 16 for rejecting undesirable signals that are closely spaced in frequency to desirable signals. The advantage of using a superconducting filter is its ability to provide a precise narrow pass band around the desired signals with low insertion loss due to its low resistivity. This allows the superconducting filter 30 to provide sharp frequency selectivity without adversely affecting the signal sensitivity of the receiver 16.

Therefore, the filter network 100 according to the present invention exhibits high frequency selectively and low insertion loss without many of the disadvantages associated with a superconducting filter. This is achieved by pre-filtering the RF signals with the non-superconducting filter 20 before inputting the RF signals to the superconducting filter 30. That way, catastrophic failure due to high power out-of-band signals and performance degradation due to in-band intermodulation spurious signals are reduced.

The transmitter system 110 may be coupled to the antenna 12 for sending, for example, RF signals 115, and may include a filter network 150 for filtering the transmitted signals, and a transmitter 125 for producing the transmitted signal. The filter network 150 may be used to selectively pass transmit signals within a designated band to another receiver (not shown), for example a cellular telephone, through, for example antenna 12, via a transmit RF signal 115. When the antenna is not shared by the receive and transmit signals, then separate antennas can be used (not shown), one for the receive signal 15 and the other for the transmit signal 115.

The filter network 150 may comprise a non-superconducting filter 120 and a superconducting filter 130. The superconducting filter 130 may be a High Temperature Superconducting (ES) filter. In this example, the superconducting filter 130 may receive transmit signals from the transmitter 125. The output of the superconducting filter 130 may be coupled to the non-superconducting filter 120, and the non-superconducting filter 120 may be coupled to, for example, the antenna 12. The superconducting filter 130 may pre-filter the transmit signals before they are filtered by the non-superconducting filter 120.

The superconducting filter 130 may be, for example, a notch or band reject filter that is tuned to clip or reject a transmit signal just outside of the desired transmit frequency and then pass the remaining signal to the non-superconducting filter 130, which may be, for example, a band pass filter tuned to pass the transmit signals having a frequency within a pass band. Preferably, the pass band encompasses a transmit frequency range of the base station. For example, the base station may be using the Advanced Mobile Phone Service (AMPS) standard having, for example, the total transmitting frequency range is approximately 869 MHz to 894 MHz. Other telecommunications and cellular operators use, or plan to use, other frequency ranges (e.g. 862 MHz to 869 MHz) to which the invention described herein may also apply. By setting the superconductor filter to clip or reject signals at frequencies just outside the pass band, the superconducting filter 130 does not need to have the same high power characteristics of the typical band pass filter used in cellular telephone base station transmitters. As a result, the transmit filter network 150 may have exhibit improved very low loss performance within at least one of the pass band edges as will be explained in more detail below.

Therefore, the transmit filter network 150 through use of a superconductor filter may reject out-of-band noise power without using a high power superconductor filter or other analog or digital technique traditionally used in the transmitter power amplifiers to achieve noise reduction. As will be described in more detail below, the superconducting filter may be used to clip the transmit signal close to the lower transmit pass band edge and/or the upper transmit pass band edge. In the case of clipping the transmit signal at both the lower transmit pass band edge and the upper transmit pass band edge, two superconducting filters may be used.

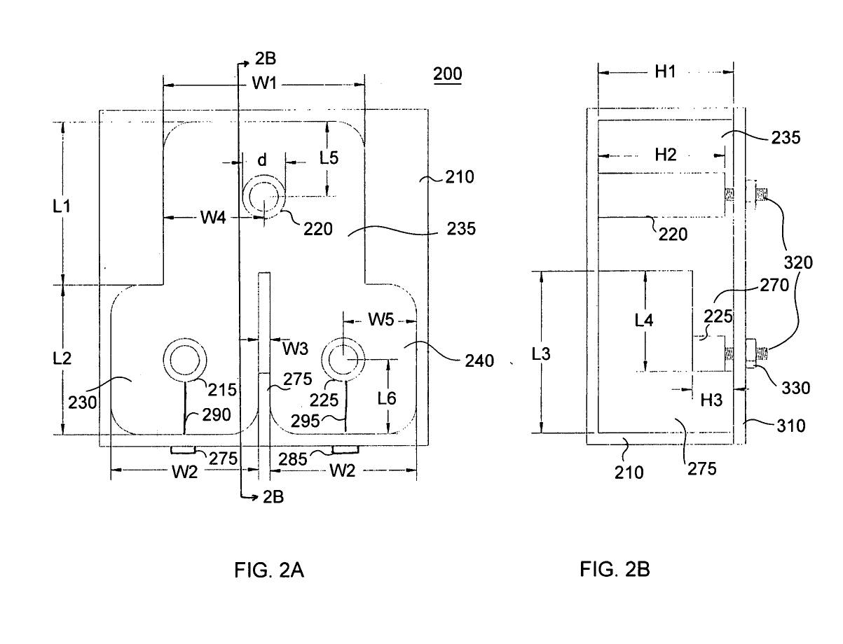

FIG. 2A of a non-superconducting filter 200 according to one embodiment of the present invention. The non-superconducting filter 200 comprises a housing 210 enclosing three round-rod resonators 215, 220 and 225. Alternatively, the resonators 215, 220 and 225 can be waveguide resonators, cavity resonators, dielectric resonators, stripline resonators, or other resonators known in the art The housing 210 and resonators 215, 220 and 225 may be machined from aluminum and silver plated to minimize insertion loss. The resonators 215, 220 and 225 are placed in three cavities 230, 235, and 240, respectively, formed inside the housing 210, creating coaxially resonant structures. The input 275 and the output 285 of the non-superconducting 200 filter are directly coupled 290 and 295 to resonators 215 and 225, respectively. Alternatively, the input 275 and the output 285 may be coupled to the resonators 215 and 225, respectively, using capacitors, inductors or any other coupling technique used by those skilled in the art

FIG. 2B shows a cross-sectional view of the non-superconducting filter 200 taken along line 2B in FIG. 2A. FIG. 2B shows a top plate 310 placed over the housing 210 of the non-superconducting filter 200. In addition, tuning screws 320 are inserted into each resonator 215, 220 and 225 though the top plate 310. The tuning screws 320 are secured to the top plate 310 by nuts 330. The functionality of the tuning screws 320 will be discussed later.

Each resonator 215, 220 and 225 is electro-magnetically coupled to each one of the other two resonators 215, 220 and 225 through apertures in the housing 210. The aperture coupling resonators 215 and 220 is shown in FIG. 2A as the opening between cavities 230 and 235. The aperture coupling resonators 220 and 225 is shown in FIG. 2A as the opening between cavities 235 and 240. The aperture coupling resonators 215 and 225 is best shown in FIG. 2B as an opening 270 in a housing wall 275 positioned between resonators 215 and 225. Alternatively, the resonators can be coupled to each other using transformers or capacitors.

The turning screws 320 are used to adjust the capacitance of the resonators 215, 220 and 225. Turning the tuning screws 320 inwardly increases the capacitance of the resonators 215, 220 and 225, which lowers the resonance frequency of the resonators 215, 220 and 225. Turning the tuning screws 320 outwardly decreases the capacitance of the resonators, which increases the resonance frequency of the resonators 215, 220 and 225.

The non-superconducting filter 200 of FIGS. 2A and 2B produces a first pass band and a finite frequency transmission zero positioned at a frequency outside the first pass band. The finite frequency transmission zero provides enhanced rejection of signals located in its vicinity. The position of the finite frequency transmission -zero can be controlled by adjusting the dimensions of the aperture coupling resonators 215 and 225. Preferably, the finite frequency transmission zero is positioned at a frequency within a frequency range containing powerful interferers to provide enhanced rejection of these interferers. For example, the co-located transmission signals transmitted by the transmitter side of the base station can be powerful due to the proximity between the transmitter and receiver side of the base station. In this example, the finite frequency transmission zero can be positioned at a frequency inside the transmitting frequency range of the base station to enhance rejection of the co-located transmission signals. For base stations using the AMPS standard, for example, the transmitting frequency range is approximately 869 MHz to 894 MHz, which is located near the receiving frequency range of 824 MHz to 849 MHz. The finite frequency transmission zero can be positioned at a frequency either above or below the first pass band, depending on the location of interferers.

In one specific example of the non-superconducting filter 200 in FIGS. 2A and 2B, the non-superconducting filter 200 structure has the dimensions given below. The housing 210 has a height H1 of 2.30 inches. Chamber 235 has a width W1 of 3.50 inches and a length L1 of 2.75 inches, and chambers 230 and 240 each have a width W2 of 2.55 inches and a length L2 of 2.55 inches. Each one of the resonators 215, 220 and 225 has a diameter d of 0.75 inches and a height H2 of 2.15 inches. The center of resonator 220 is positioned in chamber 235 a length L5 of 1.275 inches from one side of the housing 210 and width W4 of 1.75 from another side of the housing 210. The center of resonator 225 is position in chamber 240 a length L6 of 1.275 inches from one side of the housing 210 and a width W5 of 1.275 from another side of the housing 210. The center of resonator 215 is in the same relative position in chamber 230 as the center of resonator 235 is in chamber 240. The housing wall 275 separating resonators 215 and 225 has a width W3 of 0.20 inches and a length L3 of 2.75 inches. Finally, the aperture 270 coupling resonators 215 and 225 has a height H3 of 0.70 inches and a length L4 of 1.70 inches.

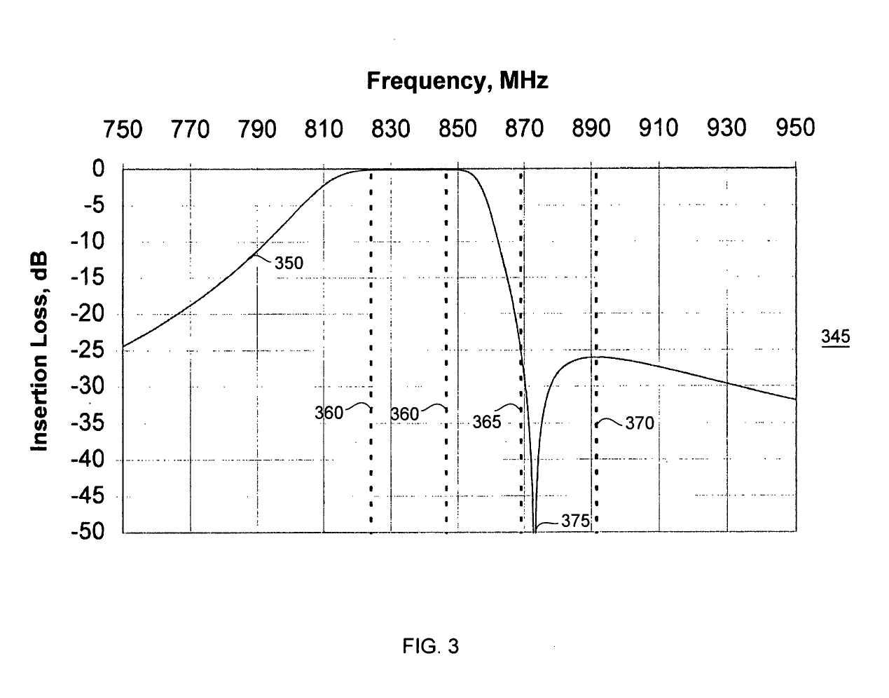

FIG. 3 shows a plot 345 of the frequency response of a non-superconducting filter 200 made from silver-plated aluminum and having the above dimensions. Specifically, the plot 345 shows an insertion loss 350 measured in decibels (dB) between the input 275 and the output 285 of the non-superconducting filter 200 versus frequency in the range of 750 MHz to 950 MHz. The filter 200 passes frequencies at which the insertion loss 350 is low and rejects frequencies at which the insertion loss 350 is high (in an absolute number sense as the numbers plotted are actually insertion gain (S21 in dB), which are negative). It is common practice to call this insertion loss as the devices are passive and cannot have gain). In FIG. 3, the insertion loss 350 is low within a receiving frequency range of about 824 MHz to 849 MHz, which is bounded by lines 355 and 360. In contrast, the insertion loss is high within a transmitting frequency range of 869 MHz to 894 MHz, which is bounded by lines 365 and 370. Thus, the non-superconducting filter 200 measured in plot 345 passes signals within the receiving frequency range of 824 MHz to 849 MHz, while rejecting signals within the transmitting frequency range of 869 MHz to 894 MHz. These frequency ranges correspond to the receiving and transmitting frequency ranges used by cellular base stations in the AMPS standard.

In this specific example, the effect of the cross coupling between the resonators 215, 220 and 225 produces a finite frequency transmission zero, which can been seen as a deep spike 375 in the insertion loss 350 in the plot 345. This transmission zero is located inside the base station transmitting frequency range of 869 MHz to 894 MHz and provides enhanced rejection of frequencies within this frequency range.

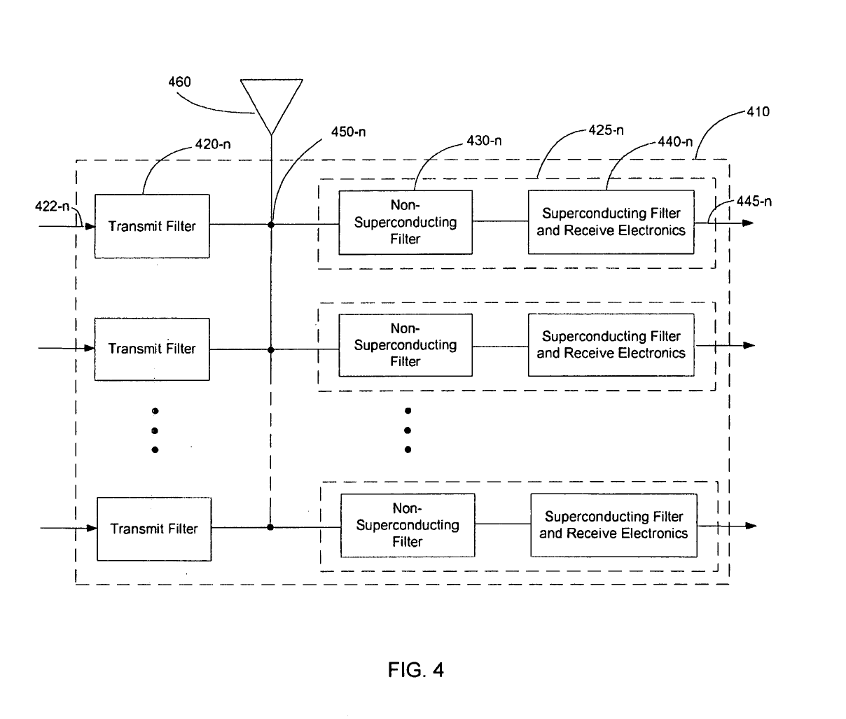

FIG. 4 shows a multiplexer 410 according to one embodiment of the present invention (for example the cellular duplexers DUP850A and DUP850B from Superconductor Technologies Inc.). The multiplexer 410 comprises at least one transmit filter 420-n and at least one receive filter network 425-n. The receive filter network 425-n further comprises a non-superconducting filter 430-n, and a superconducting filter and receive electronics 440-n. The output of the transmit filter 420-n and the input of the receive filter network 425-n are coupled to a common antenna port 450-n. The transmit filter 420-n and the receive filter network 425-n may be coupled to the common antenna port 450-n by an interconnecting phasing network (not shown), the construction of which is well known in the art. The common antenna port 450-n is coupled to an antenna 460, for example, through a cable. The multiplexer 410 may be located in close proximity to the antenna 460. For example, the multiplexer 410 and the antenna 460 may be mounted to the same antenna tower. Alternatively, the multiplexer 410 may be located away from the antenna 460, such as in a base station.

The transmit filter 420-n filters incoming transmit signals 422-n from the transmitter side of a base station (not shown). The transmit-filter 420-n may be, for example, a band pass filter constructed to pass signals within a transmitting frequency range of the base station, for example, approximately 869 MHz to 894 MHz for the AMPS standard. In one variation, the transmit filter 42O-n may include a superconducting filter. The transmit filter 420-n may include one or more finite frequency transmission zeros for providing enhanced rejection of signals located outside of the transmitting frequency range, such as the receive signals on the common antenna port 450-n.

The non-superconducting filter 430-n of the receive filter network 425-n pre-filters receive signals from the antenna 460. The non-superconducting filter 430-n is a bandpass filter constructed to pass signals within a receiving frequency range of the base station, for example, 824 MHz to 849 MHz for the AMPS standard. The non-superconducting filter 430-n may include one or more finite frequency transmission zeros for providing enhanced rejection of signals located outside of the receiving frequency range, such as the transmit signals on the common antenna port 450-n. The superconducting filter 440-n is a sharp bandpass filter for providing high frequency selectivity of the receive signals. The receive electronics 440-n further processes the receive signals. The receive electronics 440-n may include a Low Noise Amplifier (LNA), which may or may not be cryogenically cooled, for amplifying the receive signals. The receive electronics 440-n may also include protection circuits for protecting the superconducting filter 440-n and/or base station (not shown) from electrical surges. The protection circuits may include gas discharge tube voltage arrestors, quarter wavelength stubs, and any other protection circuits that are well known in the art. The receive signals are outputted 445-n by the receive filter network 425-n to the receiver side of a base station (not shown).

The multiplexer 410 according to the present invention enables the same antenna 460 to both transmit and receive signals, thereby reducing costs. This is achieved by coupling the transmit filter 420-n and the receive filter network 425-n to the common antenna port 450-n of the multiplexer 410, and coupling the common antenna port 450-n to the antenna 460.

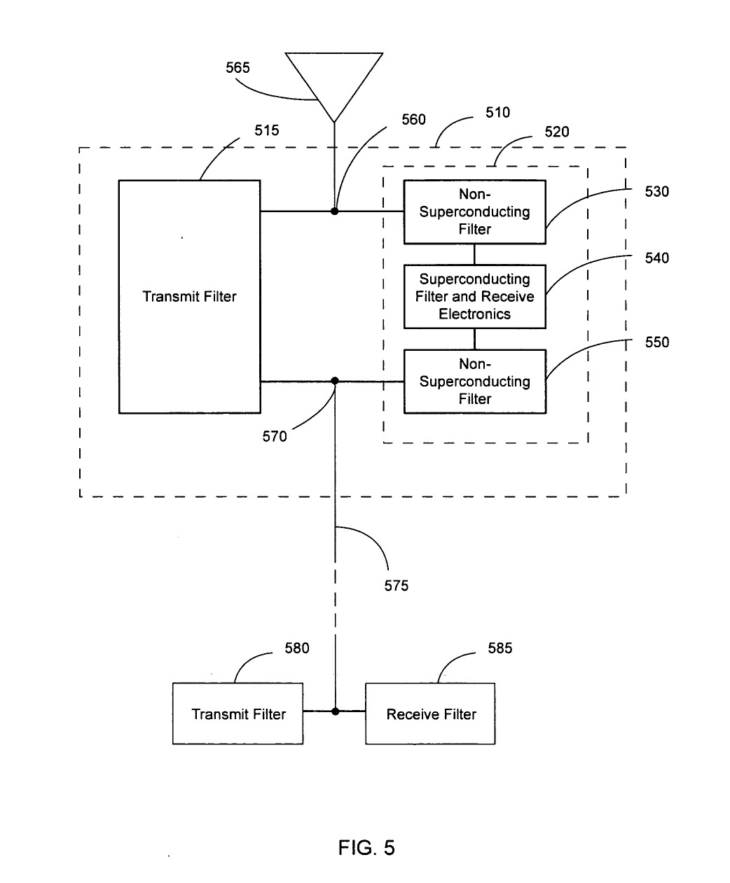

FIG. 5 shows a double duplexer 510 according to another embodiment of the present invention (e.g. as used in the AmpLink product 1900e from Superconductor Technologies Inc.). The double duplexer 510 includes a transmit filter 515 and a receive filter network 520. The receive filter network 520 further includes a first non-superconducting filter 530, a second non-superconducting filter 550, and a superconducting filter and receive electronics 540 coupled between the first and second non-superconducting filter 530, 550. The transmit filter 515 may also be a filter network that may include one or more superconducting filter(s) and/or a non-superconducting filter (similar to the receive non-superconducting filters 530 and 550). The output of the transmit filter 515 and the input of the receive filter network 520 are coupled to a common antenna port 560. The common antenna port 560 is coupled to an antenna 565, for example, through a cable. The input of the transmit filter 515 and the output of the receive filter network 520 are coupled to a common port 570. The common port 570 is coupled to a base station (not shown) through a cable 575.

The transmit filter 515 filters incoming transmit signals from the base station (not shown) in a manner similar to the transmit filter 420-n of the multiplexer 410. The first non-superconducting filter 530 pre-filters receive signals from the antenna 565 in a manner similar to the non-superconducting filter 430 of the multiplexer 410. The superconducting filter 540 is a sharp bandpass filter for providing high frequency selectivity of the receive signals. The receive electronics 540 further processes the receive signal in a manner similar to the receive electronics 440-n of the multiplexer 410. The second non-superconducting filter 550 is a bandpass filter that passes the receive signals to the common port 570 while blocking the transmit signals on the common port 570 from the entering the receive electronics 540. The second non-superconducting filter 550 may be the identical to the first non-superconducting filter 530.

The double-duplexer 510 according to the present invention enables the same antenna 565 to both transmit and receive signals, thereby reducing costs. In addition, the double-duplexer 510 enables the transmit signals and the receive signals to flow between the double-duplexer 510 and the base station (not shown) through the common port 570. As a result, a single cable 575 can be used to coupled the double-duplexer 510 to the base station. Because the base station uses a single cable 575 to both transmit signals to and receive signals from the double-duplexer 510, additional filters may be needed to split the transmit and receive signals at the base station. This may be accomplished by providing a transmit filter 580 between the transmitter side of the base station (not shown) and the cable 575, and a receive filter 585 between the receiver side of the base station (not shown) and the cable 575.

Although, the double-duplexer 510 was described as including one transmit filter 515 and one receive filter network 520, those skilled in the art will appreciate that any number of transmit filters and receive filter network may be added to the double-duplexer to realize a double-multiplexer.

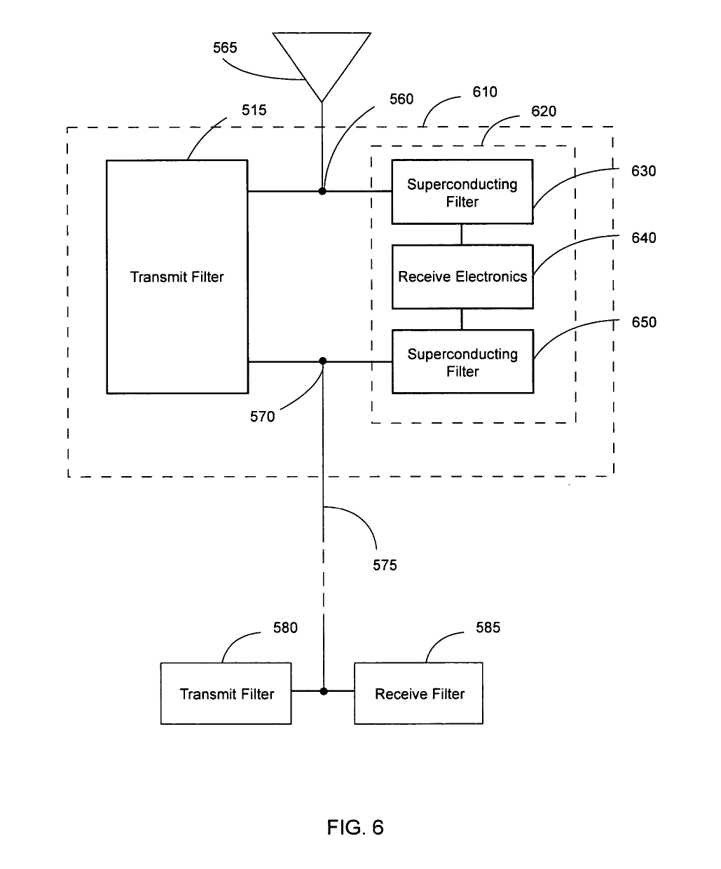

FIG. 6 shows a double-duplexer 610 according to another embodiment of the present invention. In this embodiment, the receive filter network 620 includes a first superconducting filter 630, a second superconducting filter 650, and receive electronics 640 coupled between the first and second superconducting filter 630, 650. The first superconducting filter 630 is a sharp bandpass filter for providing high frequency selectivity of the receive signals from the antenna 565. The receive electronics 630 further processes the receive signals and may include an LNA and protection circuits. The second superconducting filter 650 is a bandpass filter that passes the receive signals to the common port 570 while blocking transmit signals on the common port 570 from entering the receive electronics 640. Alternatively, the second superconducting filter 650 may be replaced by a non-superconducting filter.

Additionally, to alleviate catastrophic failure of the receive side of the systems shown in FIGS. 4 and 5, a switched bypass (not shown) may be used. In the event of an electrical surge or fault in a receive path of the systems, the switched bypass directs the receive signals around the superconducting filters shown in the receive electronics 440-n and 540. Also included in this bypass function may be one or more low noise amplifiers, which may or may not be cooled, along with any other circuitry in the path of the receive signals that may be considered prone to failure.

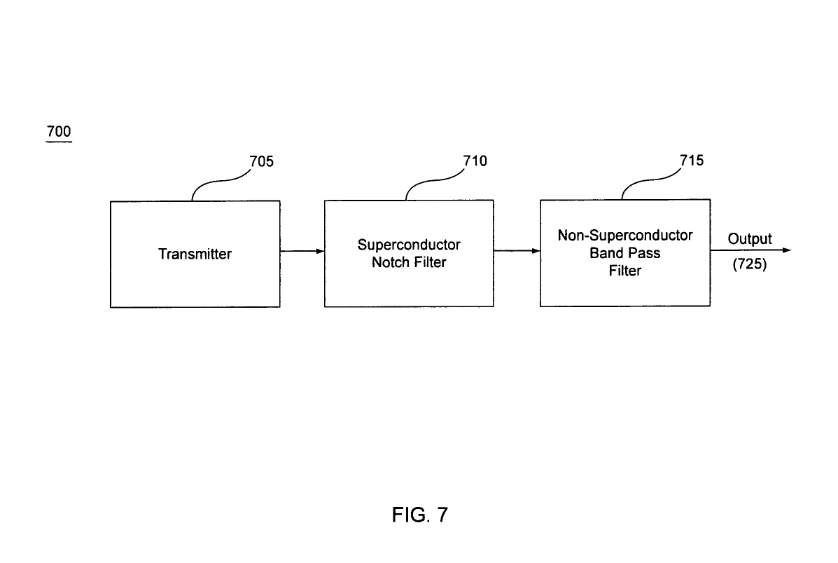

A more detailed description will now be provided regarding the transmission side of the communication system and transmit filtering. Referring to FIG. 7, a transmit network is shown according to at least one exemplary embodiment. In this embodiment the transmit network 700 may included, for example, a transmitter 705 for generating communication signals to be transmitted within a communication system. The signals may be, for example, electronic communication signals. The output of transmitter 705 may be coupled to, for example, a superconductor notch filter 710 (or band reject filter). Superconductor notch filter 710 may be designed to remove signals of a frequency close to the desired transmit frequency output by the transmitter 705. The superconductor notch filter 710 may be an HTS filter that may be configured from a plurality of resonators. The output of the superconductor notch filter 710 may be coupled to a non-superconductor band pass filter 715. The non-superconductor band pass filter 715 may filter the signal from the superconductor notch filter 710 to be within the desired pass band frequency range of the transmitter 705 and output it to the communication system via output 725. In, for example, a cellular telephone communication system the output 725 may be couple to, for example, a base station antenna.

The superconductor notch filter 710 may use HTS resonators to form a very sharp notch filter that when combined with a non-superconductor band pass filter 715 results in enhance rejection characteristics. The close to operating band rejection may be dominated by the notch filter 710 and the further away from the operating band rejection may be dominated by the band pass filter 715. The stored energy in the HTS notch filter 710 may be targeted mainly outside the operating band so as to enable the use of superconductor structures, for example resonators, that do not need to have high power power handling capabilities, i.e., the superconductor notch filter 710 needs only relatively low power handling capabilities. The use of a superconductor notch filter 710 may also enable the design of the transmitter power amplifiers (not shown), for which the filters are needed to reduce out-of-band noise power, to be simplified because the power amplifiers may now generate more noise that will be reduced by the superconductor notch filter 710.

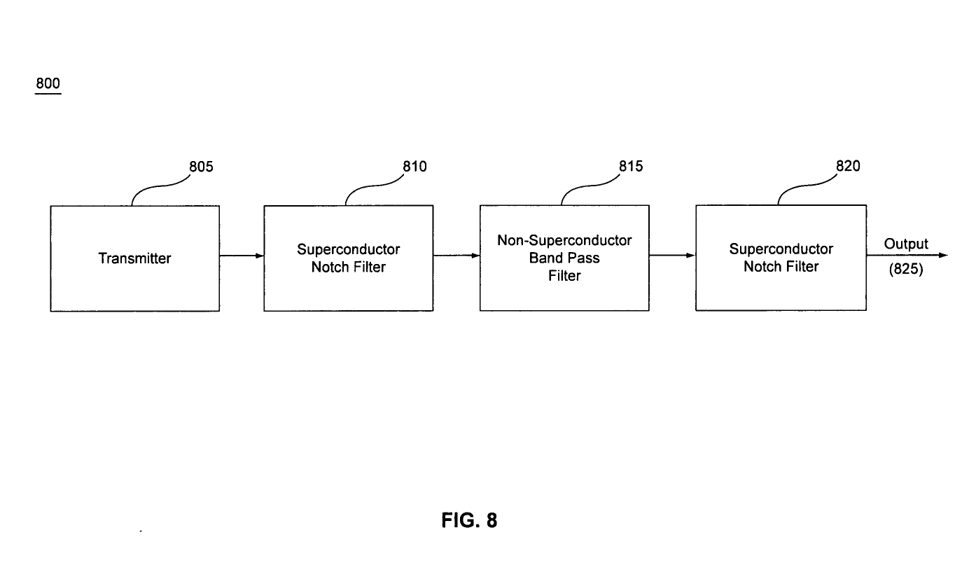

Referring to FIG. 8, another transmit network is shown according to at least one exemplary embodiment. In this embodiment, multiple notch filters 810 and 820 may be used to generate an apparent very sharp band pass response on both sides of the desired transmit pass band, with very low pass band losses. In this embodiment the transmit network 800 may included, for example, a transmitter 805 for generating communication signals to be transmitted within a communication system. The signals may be, for example, electronic communication signals. The output of transmitter 805 may be coupled to, for example, a first superconductor notch filter 810 (or band reject filter). Superconductor notch filter 810 may be designed to remove signals of a frequency close to the desired transmit frequency output by the transmitter 805, for example near the lower end of a pass band range. The superconductor notch filter 810 may be an HTS filter that may be configured from a plurality of resonators. The output of the superconductor notch filter 810 may be coupled to a non-superconductor band pass filter 815. The non-superconductor band pass filter 815 may filter the signal from the superconductor notch filter 810 to be within the desired pass band frequency range of the transmitter 805. The output of the non-superconductor notch filter 815 may be coupled to a second superconductor notch filter 820.). Superconductor notch filter 820 may be designed to remove signals of a frequency close to the desired transmit frequency, for example just above the higher frequency end of a pass band range. The filtered transmit signal may then be output from the second superconductor notch filter 820 to the communication system, via output 825. In, for example, a cellular telephone communication system the output 825 may be couple to, for example, a base station antenna. Various alternative filter arrangements are possible. For example, in at least one embodiment of this invention, the second superconducting notch filter 820 may be located before the non-superconductor band pass filter 815, so that both superconductor notch filters are between the transmitter 805 and the non-superconductor band pass filter 815. In at least one further embodiment of the invention where the two superconducting notch filters are connected together before the non-superconductor band pass filter, another non-superconducting band pass filter, similar to the first non-superconductor band pass filter 815, can be inserted between the transmitter 805 and first superconductor notch filter 810.

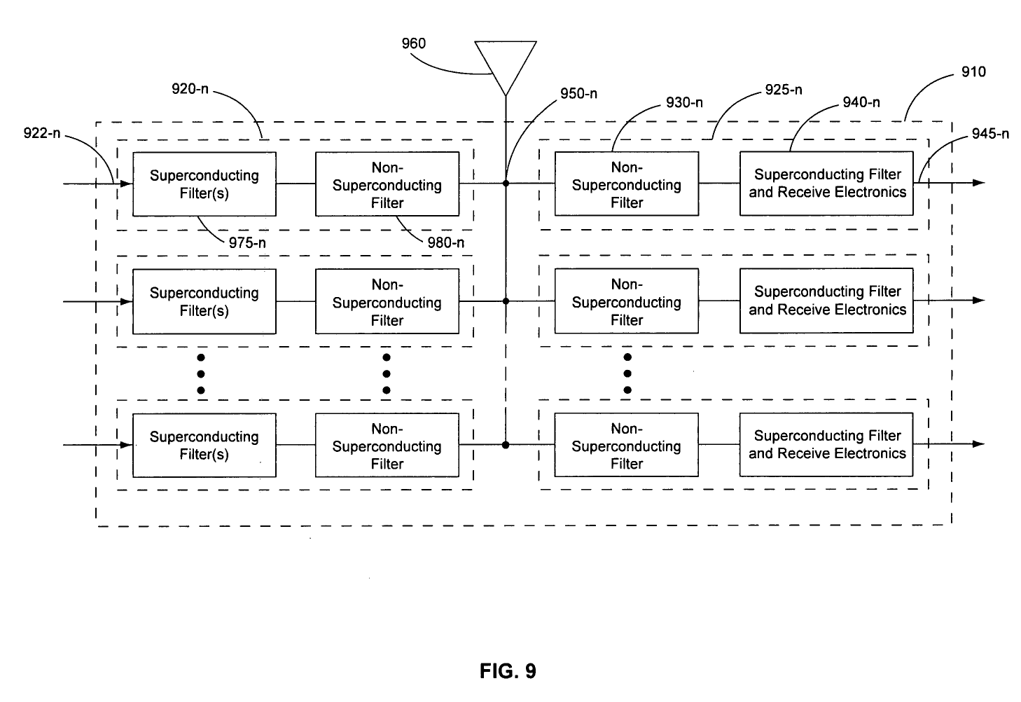

FIG. 9 shows a multiplexer 910 according to one exemplary embodiment of the present invention. Multiplexer 910 is similar to multiplexer 410, but shows the use of superconducting filters 975-n and non-superconducting filter 980-n for the transmit filter 920-n. The multiplexer 910 comprises at least one transmit filter 920-n and at least one receive filter network 925-n. The receive filter network 925-n further comprises a non-superconducting filter 930-n, and a superconducting filter and receive electronics 940-n. The output of the transmit filter 920-n and the input of the receive filter network 925-n are coupled to a common antenna port 950-n. The transmit filter 920-n and the receive filter network 925-n may be coupled to the common antenna port 950-n by an interconnecting phasing network (not shown), the construction of which is well known in the art. The common antenna port 950-n is coupled to an antenna 960, for example, through a cable. The multiplexer 910 may be located in close proximity to the antenna 960. For example, the multiplexer 910 and the antenna 960 may be mounted to the same antenna tower. Alternatively, the multiplexer 910 may be located away from the antenna 960, such as in a base station.

The transmit filter 920-n filters incoming transmit signals 922-n from the transmitter of a base station (not shown). The transmit filter 920-n may include, for example, a superconducting filter 975-n coupled to a non-superconducting filter 980-n. The coupling between the superconducting filter 975-n and the non-superconducting filter 980-n may include a phasing network. The superconducting filter 975-n may be a notch filter or band reject filter and the non-superconducting filter 980-n may be a band pass filter, both constructed so as to pass signals within a transmitting frequency range of the base station, for example, approximately 869 MHz to 894 MHz for the AMPS standard. Superconductor filters 975-n may be comprised of one or more superconductor filters that may operate at the same and/or different frequencies. The transmit filter 920-n may filter the incoming transmit signals 922-n, for example RF signals, so that an improved filtered signal is provided to port 950-n that is shared with the receive signals on the common antenna port 950-n.

The receiver side of the multiplexer 910 may include one or more receive filter networks 925-n. Although the filter networks 925-n are shown to include superconducting filter(s), it may be constructed with only non-superconducting filter(s). In this example, the non-superconducting filter 930-n of the receive filter network 925-n pre-filters receive signals from the antenna 960. The non-superconducting filter 930-n is a band pass filter constructed to pass signals within a receiving frequency range of the base station, for example, 824 MHz to 849 MHz for the AMPS standard. The non-superconducting filter 930-n may include one or more finite frequency transmission zeros for providing enhanced rejection of signals located outside of the receiving frequency range, such as the transmit signals on the common antenna port 950-n. The superconducting filter 940-n is a sharp band pass filter for providing high frequency selectivity of the receive signals. The receive electronics 440-n further processes the receive signals. The receive electronics 940-n may include, for example, a Low Noise Amplifier (LNA), which may or may not be cryogenically cooled, for amplifying the receive signals. The receive electronics 940-n may also include protection circuits for protecting the superconducting filter 940-n and/or base station (not shown) from electrical surges. The protection circuits may include gas discharge tube voltage arrestors, quarter wavelength stubs, and any other protection circuits that are well known in the art. The receive signals are outputted 945-n by the receive filter network 925-n to the receiver side of a base station (not shown).

The multiplexer 910 according to the present invention enables the same antenna 960 to both transmit and receive signals, thereby reducing costs. This is achieved by coupling the transmit filter 920-n and the receive filter network 925-n to the common antenna port 950-n of the multiplexer 910, and coupling the common antenna port 950-n to the antenna 960.

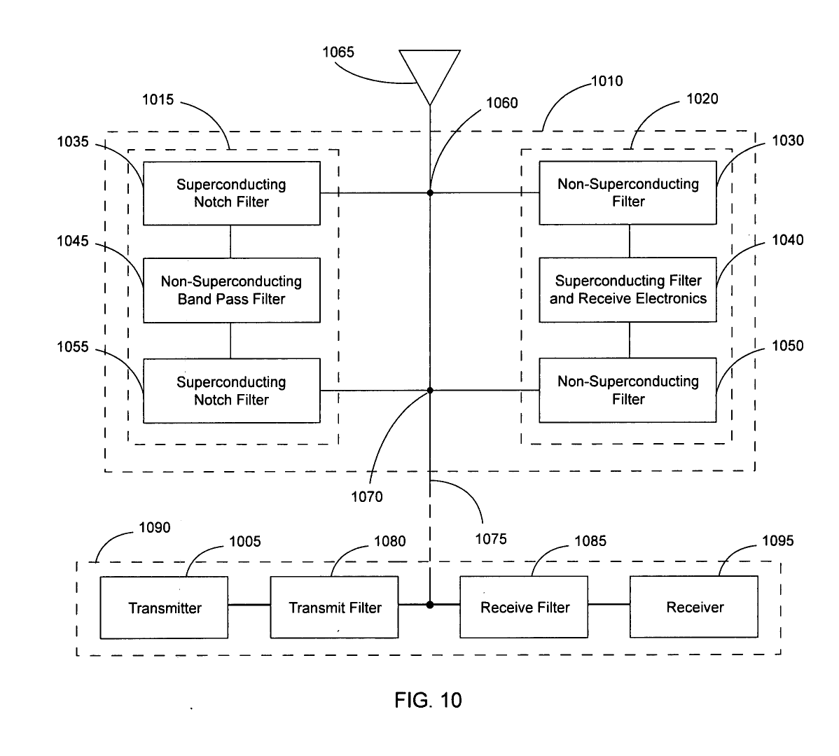

FIG. 10 shows a double duplexer 1010 according to another embodiment of the present invention. The double duplexer 1010 includes a transmit filter 1015 and a receive filter network 1020. The receive filter network 1020 may further include a first non-superconducting filter 1030, a second non-superconducting filter 1050, and a superconducting filter and receive electronics 1040 coupled between the first and second non-superconducting filter 1030, 1050. The transmit filter network 1015 may also include a filter network that may include one or more superconducting filter(s) 1035 and 1055 and/or a non-superconducting filter 1045. Superconducting filter(s) 1035 and 1055 may be, for example, notch filters or band reject filters. The non-superconducting filter 1045 may be, for example, a band pass filter. A transmitter 1005 may be coupled to the transmit filter 1080 and provide a transmit signal to be sent through a communication system, for example, a wireless communication system. Alternatively, the transmitter 1005 may be coupled to the first transmit superconducting notch filter 1055, and the receiver 1095 may then be coupled to the first non-superconductor filter 1050. The notch filter 1055 may also be coupled to a common port 1070 and a non-superconducting band pass filter 1045. The non-superconducting band pass filter 1045 may be coupled to a second superconducting notch filter 1035. The second superconducting notch filter 1035 may also be coupled to common port 1060, which is couple to, for example, and antenna 1065. The superconductor notch filters 1035 and 1055 may be, for example, an HTS filter that may be cryogenically cooled to a desired operating temperature. As constructed, this transmit filter network will have very sharp signal rejection at the lower and upper boundaries of the desired transmit pass band. The output of the transmit filter 1015 and the input of the receive filter network 1020 may both be coupled to the common antenna port 1060 through, for example, a phasing network (not shown). The common antenna port 1060 may be coupled to an antenna 1065, for example, through a cable. The input of the transmit filter 1015 and the output of the receive filter network 1020 may both be coupled to a common port 1070. The common port 1070 may be coupled to, for example, a base station (not shown) through a cable 1075.

The transmit filter 1015 may filter incoming transmit signals from the base station transmitter 1005 in a manner similar to the transmit filter 920-n of the multiplexer 910. Although the receiver filter network 1020 is shown having a superconducting filter 1040, one variation may have the filter network 1020 without a superconductor filter 1040. How-ever, in this example, the first non-superconducting filter 1030 may pre-filter receive signals from the antenna 1065 in a manner similar to the non-superconducting filter 930 of the multiplexer 910. The superconducting filter 1040 may be a sharp band pass filter for providing high frequency selectivity of the receive signals. The receive electronics 1040 may further process the receive signal in a manner similar to the receive electronics 940-n of the multiplexer 910. The second non-superconducting filter 1050 may be a band pass filter that passes the receive signals to the common port 1070 while blocking the transmit signals on the common port 1070 from the entering the receive electronics 1040. The second non-superconducting filter 1050 may be the identical to the first non-superconducting filter 1030.

The double-duplexer 1010 according to the present embodiment may enable the same antenna 1065 to both transmit and receive signals, thereby reducing costs. In addition, the double-duplexer 1010 may enable the transmit signals and the receive signals to flow between the double-duplexer 1010 and the base station (not shown) through the common port 1070. As a result, a single cable 1075 may be used to couple the double-duplexer 1010 to the base station. Because the base station uses a single cable 1075 to both transmit signals to and receive signals from the double-duplexer 1010, additional filters may be needed to split the transmit and receive signals at the base station. This may be accomplished by providing a transmit filter 1080 between the transmitter side of the base station 1090 and the cable 1075, and a receive filter 1085 between the receiver side of the base station 1090 and the cable 1075.

Although, the double-duplexer 1010 was described as including one transmit filter 1015 and one receive filter network 1020, those skilled in the art will appreciate that any number of transmit filters and receive filter network may be added to the double-duplexer to realize a double-multiplexer.

In another embodiment of this invention, similar to the alternative as described in FIG. 8, the second superconducting notch filter 1035 may be located before the non-superconductor band pass filter 1045, so that both superconductor notch filters are between the junction 1070 and the non-superconductor band pass filter 1035. In a further embodiment of the invention where the two superconducting notch filters 1035 and 1055 are connected together before the non-superconductor band pass filter 1045, another non-superconducting band pass filter, similar to 1045, can be inserted before the superconductor notch filters 1035 and 1055 and may be coupled to connection 1070 through a phasing network (not shown).

A more detailed explanation for the transmit filter network approach of the present invention will now be provided. The basic objective is to improve the rejection characteristics of a band pass filter close to the pass band edges. This is particularly useful in high power applications. The transmit filter network with superconductor filters accordingly may have very low insertion loss at the edge of the operating frequency band of the transmitter (e.g., after the transmitter power amplifier), while simultaneously rejecting the output signal energy of the transmitter (or power amplifier) very close to the operating band edge. One approach is to provide, for example, an HTS based out-of-band notch filter or band reject filter and to cascade it with a conventional metal, dielectric or other conventional high power band pass filter, to produce a very sharp rejection characteristic of the cascaded pair. This rejection characteristic may be applied to just one side of the desired operating band or on both sides of the desired operating band of the transmitter. One or more cryogenic transmit filters may be used for a complete sectored base station and may be contained in a high vacuum dewar (or other high thermal insulation) package and may be cooled using, for example, a closed cycle Sirling, or other cryogenic technology, cooler. One or more of the receiver filters and amplifiers may also be contained in the same cryogenic enclosure.

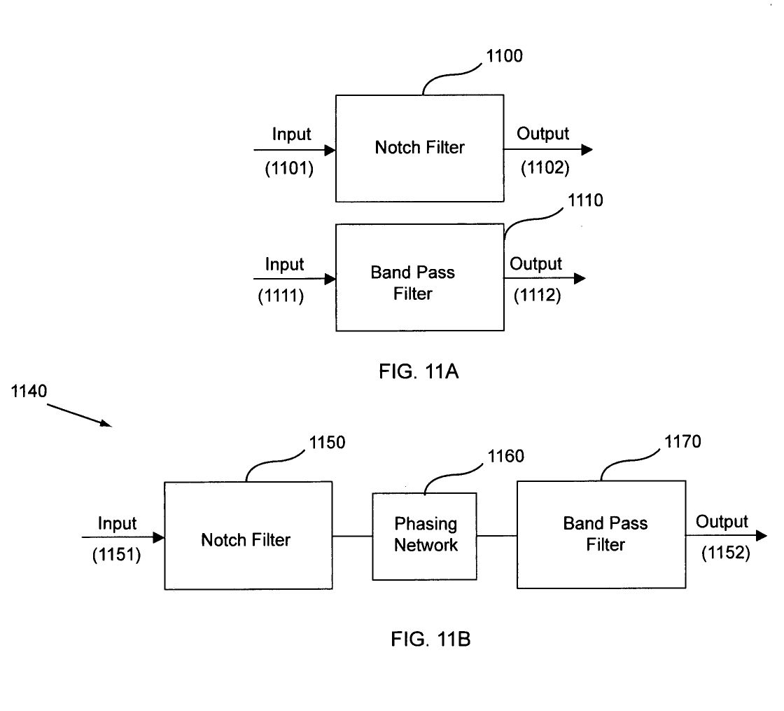

Referring now to FIGS. 11A and 11B, block diagrams are provided for helping to better explain the transmit filter concept, according to simulation of various exemplary embodiment of the present invention. The superconducting based out-of-band notch filter may be synthesized with a flat equal ripple design or a sloping ripple design. To illustrate the transmit filter performance, a notch filter 1100 and a band pass filter 1110 are considered separately as shown in FIG. 11A. FIG. 11B shows a combined notch filter 1150, band pass filter 1170 and a phasing network 1160, coupled together that are useful in simulating one exemplary embodiment for the superconductor based transmit filter. A notch filter 1100 or 1150 (e.g. similar to the HTS notch filter used in the SuperFilter II product from Superconductor Technologies, Inc.) may be, for example, a six resonator band reject filter where the resonators resonate close to but outside of the operating pass band. It was assume that these HTS resonators are cooled to an operating temperature of, for example, 77K (−196° C.) and have an unloaded Q (quality factor) of 30,000 or more. A band pass filter 1110 or 1170 (e.g. similar to the transmit filter on the HTS Ready Duplexers from Superconductor Technologies, Inc.) may be a 6 resonator, two transmission zero filter that uses resonators that are resonant inside the operating pass band of the system. The resonators may be silver plated aluminum coaxial resonators that have an unloaded Q of 5,000 or more when operated at room temperature (approximately +20° C.).

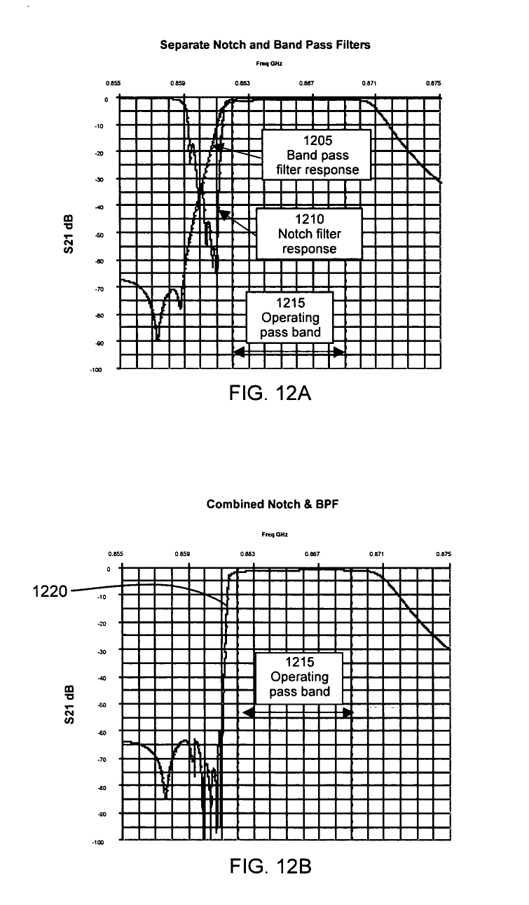

Referring now to FIG. 12A and FIG. 12B, various insertion loss graphs for the transmit filter structures illustrated in FIG. 11A and FIG. 11B are shown as results of simulation, according to one exemplary embodiment of the present invention. The computed individual insertion loss responses of the separate notch and band pass filters are shown superimposed on the same graph in FIG. 12A. Signal response trace 1205 shows the insertion loss response for band pass filter 1110. As illustrated, the band pass filter response 1205 has a reasonable slope relative to the straight operating band pass band 1215 lower boundary. On the other hand, the signal response trace 1210 for the notch filter 1100 shows a substantially vertical clipping for the notch filter response 1210.

When these filters are connected together with an appropriate phasing network, the combined computed insertion loss response is shown in FIG. 12B for the filter network 1140 shown in FIG. 11B. The effect of this combination is to apparently dramatically improve the rejection characteristics of the band pass filter, while having negligible impact on the insertion loss in the operating pass band. For example, the filter network 1140 has an insertion loss shown by trace 1220. In this case, the slope of the combined cascaded notch and band pass filters is almost completely vertical just outside the lower boundary of operating pass band 1215. Although this example only shows improvements in the rejection characteristics on one side of the pass band 1215, the process can be repeated in a similar manner to improve the rejection characteristics on the other side of the pass band 1215. Further, note that the order of the filters may be reverse, with the notch filter following the band pass filter. The order of the filters can be reversed and the same electrical performance obtained. In an embodiment where the non-superconductor transmit filter forms part of a duplexer, then the superconductor notch filter may precede the non-superconductor band pass filter.

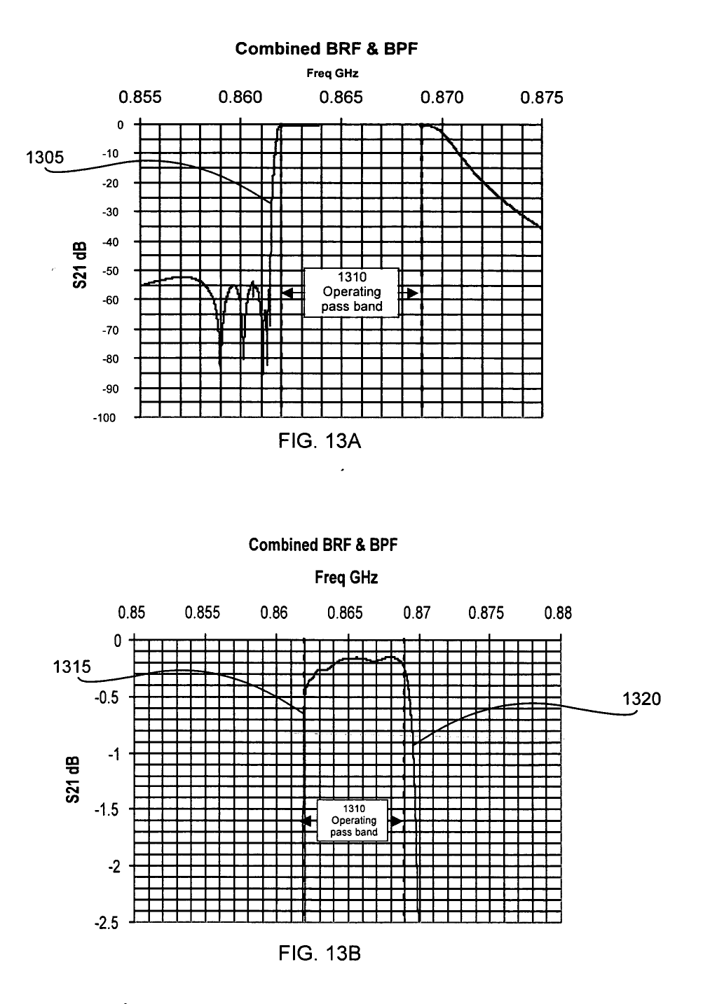

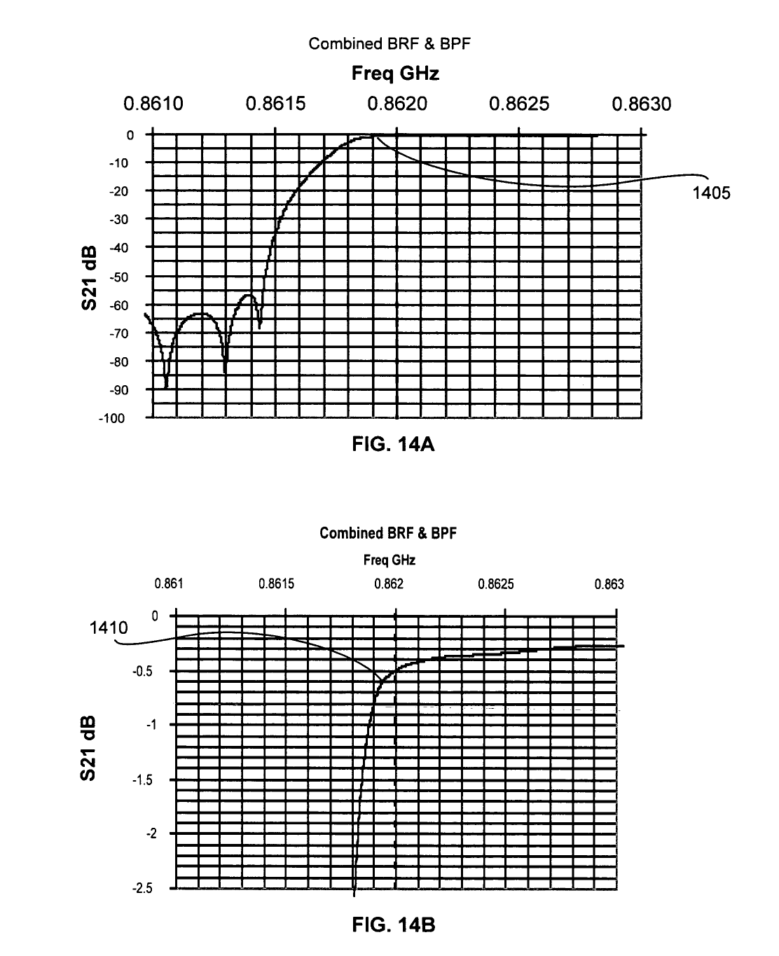

Consider now a further, more detailed example. In this exemplary embodiment a 4 resonator HTS notch filter was synthesized to have a sloping equal ripple reject response to generate the inverse of the rejection characteristic of the conventional band pass filter. FIG. 13A, FIG. 13B, FIG. 14A and FIG. 14B show various performance characteristics for the transmit filter structure illustrated in FIG. 11B but having a 4 resonator HTS notch filter 1150, according to one exemplary embodiment of the present invention. Note that this principle applies to any number of resonators in the notch filter. The notch response is done such that when the band pass and notch filters are connected together with an appropriate phasing transmission line, the rejection characteristics add to generate close to equal ripple stop band response (or other desired stop band characteristic). For this example, target rejection and band edge insertion loss of the cascaded pair was 50 dB at 861.35 MHz, 35 dB at 861.5 MHz and 0.5 dB at 862.0 MHz, with a pass band covering from 862 to 869 MHz.

The notch filter 1150 may be made from, for example, High Temperature Superconducting (HTS) thin film materials (yttrium-barium-copper-oxide (YBCO), thallium-barium-calcium-copper-oxide (TBCCO) or other HTS material), deposited on an appropriate dielectric substrate (e.g. Magnesium Oxide, Lanthanum Aluminate, Sapphire or other suitable material). Resonators with unloaded Q's from 10,000 to over 200,000 have been demonstrated at approximately 850 MHz (the cellular operating frequencies in the US) at an operating temperature of about 77K (−196° C.). A conventional 6-resonator band pass filter 1170, with two non-adjacent resonator cross-coupling paths (to produce two low side transmission zeros), made from dielectric resonators exhibiting unloaded Qs of about 25,000 at room temperature (i.e. approximately +20° C.) was assumed in the computer simulation and analysis. The computed performance 1205 of this filter by itself is shown in FIG. 12A. The specific design of this band pass filter is used merely as an example of a conventional filter. Other filter styles or resonator materials may be used in a similar manner. The cascaded notch filter 1150 and band pass filter are connected with a length of transmission line, of appropriate impedance, both the length and impedance selected to optimize the 50 dB rejection characteristic below 861.35 MHz (the selection of rejection level is arbitrary).

FIG. 13A shows the computed performance 1305 of this cascaded pair of filters. In this case, again the combined HTS notch filter 1150 and conventional low loss dielectric band pass filter 1170 performance 1305 shows an almost completely vertical signal trace just outside the low side of the operating pass band 1310, having very low loss within the pass band edge. FIG. 13B shows the computed performance on a magnified scale. The very sharp rejection characteristic on just the low side of the pass band is also apparent. In this manner it is clear that the signal trace performance 1315 on the low side of the operating pass band 1310 is essentially vertical and approximately equal to the lower limit while the signal trace 1320 on the high side of the operating pass band 1310 has a slope not as steep as the-low side (due to the absence of the out-of-band notch filter) and outside the higher pass band limit

FIGS. 14A and 14B show various graphs for low loss of the transmit filter structure illustrated in FIG. 11B, according to one exemplary embodiment of the present invention. These traces illustrate a close up of the computed performance 1405 and 1410 in the band edge region at 862 MHz. As illustrated, there is very low loss at the pass band edge while simultaneously exhibiting very steep rejection (i.e. selectivity) just outside the operating band.

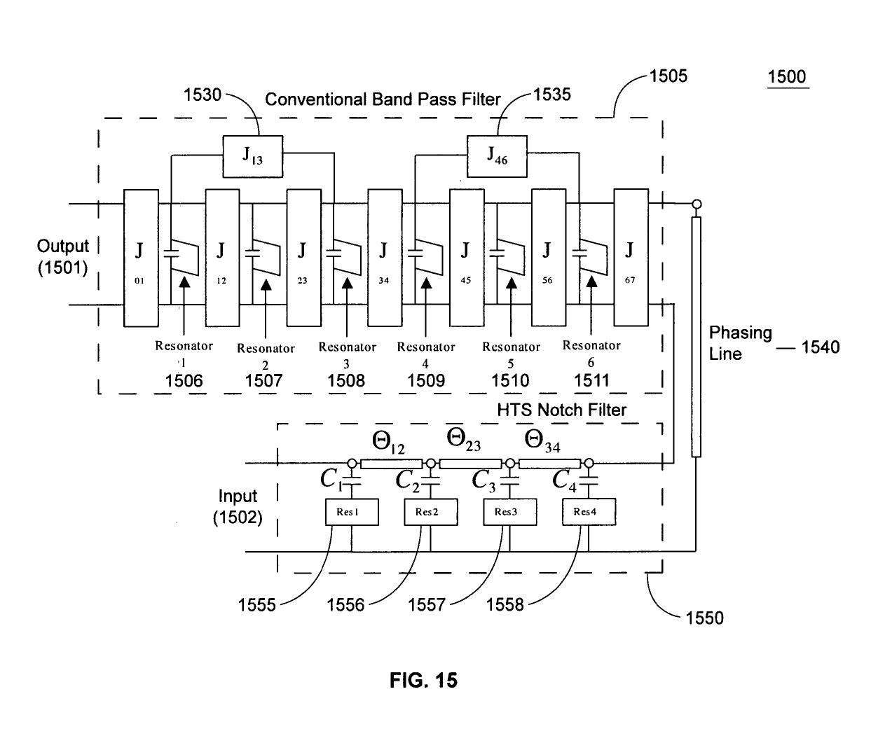

Referring now to FIG. 15, a circuit schematic of cascaded filters including a convention band pass filter and a superconductor notch filter is illustrated, according to one exemplary embodiment of the present invention. In this embodiment the filter network 1500 may include a conventional band pass filter 1505, a phasing line 1540, and an HTS notch filter 1550. The input 1502 may be coupled to a transmitter (not shown) and is the input to the HTS notch filter 1550. In this example, the conventional band pass filter 1505 has six resonators 1506-1511 coupled together in series and two extra coupling inverters J₁₃ 1530 and J₄₆ 1535 that couple non-adjacent resonators together. The inverters J₁₃ and J₄₆ may produce transmission zeros in the out-of-band response of the pass filter 1505 and may be all on one side of the pass band, or distributed between high and low sides of the pass band. The band pass filter 1505 may be, for example, dielectric, metal or other resonator technology. The number of band pass filter resonators and number of non-adjacent resonator cross couplings may be variable and depending upon specific particular application requirements. The band pass filter 1505 may be coupled to the phasing line 1540. The phasing line 1540 may be used to couple the band pass filter 1505 and the HTS notch filter 1550 together such that the rejection characteristics add constructively. The phasing line 1540 may be coupled to the notch filter 1550. The notch filter 1550 may include a plurality of resonators, in this embodiment four resonators Res1 1555, Res2 1556, Res3 1557 and Res4 1558 are used. These resonators may be similar, but not limited, to those described in the following U.S. Pat. Nos. 5,616,539, 5,618,777, 6,026,311, 6,424,846 and 6,633,208. The notch filter resonators 1555-1558 may be coupled together using, for example inductive, capacitive or a combination of both—represented here by capacitors C₁, C₂, C₃ and C₄. The notch filter 1550 inter-resonator couplings, herein represented by θ₁₂, θ₂₃, θ₃₄, may be the lengths of transmission line, and may be synthesized using lumped elements, or formed by other techniques know to those skilled in the art.

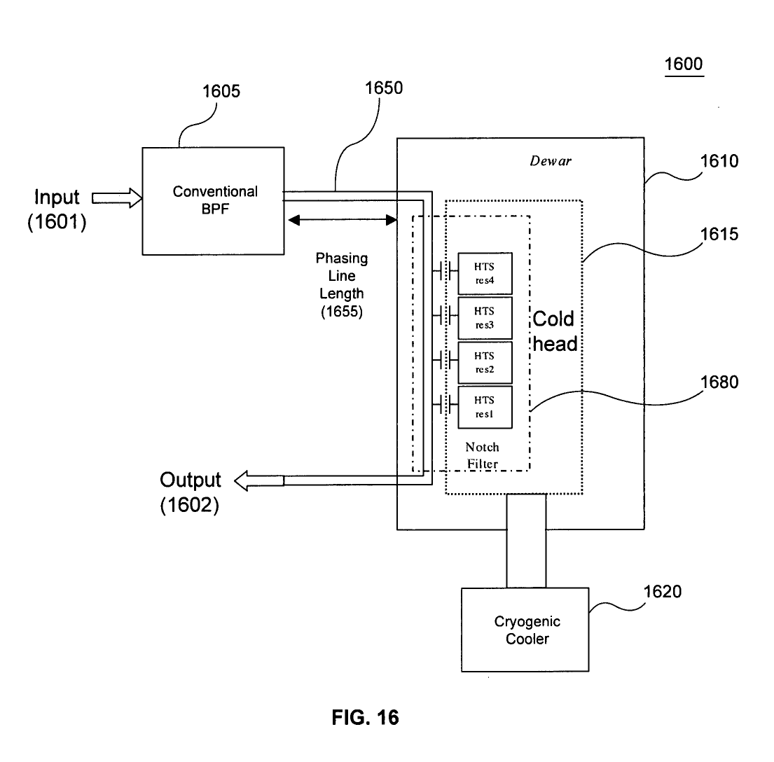

Referring now to FIG. 16, a block diagram is provided for a filter network system 1600 including one HTS filter and the cooling system for keeping the HTS cooled during operation, according to one exemplary embodiment of the present invention. A conventional band pass filter 1605 may be coupled to an input 1601 that inputs signals from, for example, a transmitter (not shown). A HTS notch filter 1680 may be included inside a cooling chamber 1610, for example a dewar or cryostat. The cooling chamber may be cooled to very low temperature using a cryogenic cooler 1620. The notch filter may be coupled to a cold head or heat sink 1615 within the cooling chamber 1610 to reduce the temperature of the HTS resonators, HTS res1, HTS res2, HTS res3 and HTS res4. The conventional BPF 1605 may be coupled to the notch filter 1680 via a phasing line 1650 having a phasing line length 1655. This configuration will produce a sharp rejection characteristic on just one side of the pass band as determine by the frequency at which the resonators are set. It should be noted that the order of the band pass filter 1605 and notch filter 1680 could be reversed if desired without impacting performance.

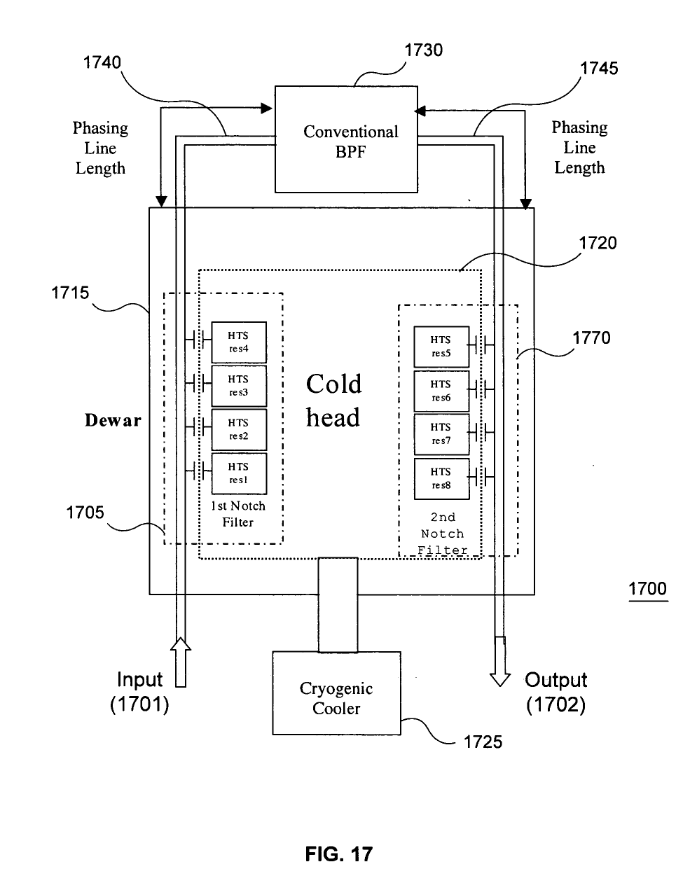

Referring now to FIG. 17, a block diagram for a filter network system 1700 including two HTS superconductor filters 1705 an 1770 coupled on either side of a non-superconductor band pass filter 1730 is provided, according to one exemplary embodiment of the present invention. A first HTS notch filter 1705 having a first resonant frequency may be coupled to an input 1701 that inputs signals from, for example, a transmitter (not shown). The first HTS notch filter 1705 may be coupled to a conventional band pass filter 1730 via a phasing line with a predetermined length 1740 that ensures the rejection characteristics add in the appropriate phase constructively, as may be understood by those skilled in the art. A second HTS notch filter 1770 may be coupled to the conventional band pass filter 1730 via a phasing line having a predetermined length 1745. Both the notch filters 1705 and 1770 may be included inside a cooling chamber 1715, for example a dewar. The cooling chamber may be cooled to very low temperature using a cryogenic cooler 1725. The notch filters 1705 and 1770 may be coupled to a cold head or heat sink 1720 within the cooling chamber 1715 to reduce the temperature of the HTS resonators, HTS res1, HTS res2, HTS res3, HTS res4, HTS res5, HTS res6, HTS res7 and HTS res8. It is noteworthy that in this case, there are four coupling locations to the cooling chamber 1715. This filter network configuration may produce sharp rejection on both the low frequency side and high frequency side of the pass band.

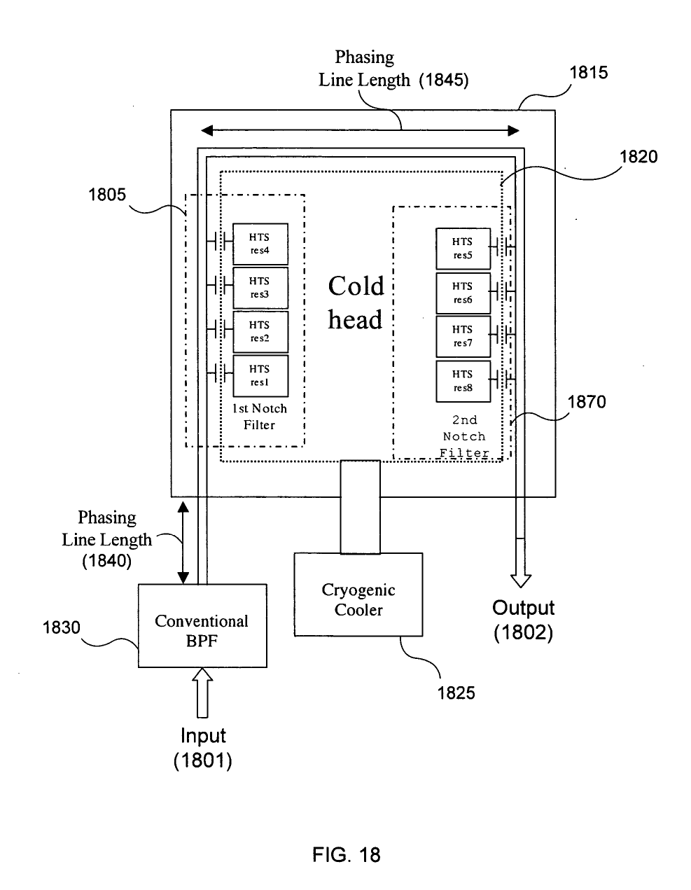

Referring now to FIG. 18, a block diagram for a filter network including two superconductor filters coupled together and to a non-superconductor filter is shown, according to one exemplary embodiment of the present invention. This embodiment is similar to the embodiment shown in FIG. 17, but configured so that the conventional band pass filter 1830 is coupled to the input 1801 resulting in the need for only two coupling locations into the cooling chamber. Input 1801 may inputs signals from, for example, a transmitter (not shown). A first HTS notch filter 1805 having a first resonant frequency may be coupled to an output of the conventional band pass filter 1830 via a phase coupling line 1840 having a predetermined length. The first HTS notch filter 1805 may be also coupled to a second HTS notch filter 1870 via a phasing line 1845 with a predetermined length. Note that the phasing line 1845 is included within the cooling chamber 1815. Both the notch filters 1805 and 1870 may also be included inside a cooling chamber 1815, for example a dewar. The cooling chamber 1815 may be cooled to very low temperature using a cryogenic cooler 1825. The notch filters 1805 and 1870 may be coupled to a cold head or heat sink 1820 within the cooling chamber 1815 to reduce the temperature of the HTS resonators, HTS res1, HTS res2, HTS res3, HTS res4, HTS res5, HTS res6, HTS res7 and HTS res8. This filter network configuration may also produce sharp rejection on both the low frequency side and high frequency side of the pass band. The input 1801 and output 1802 may be interchanged if desired without impacting the function of the invention.

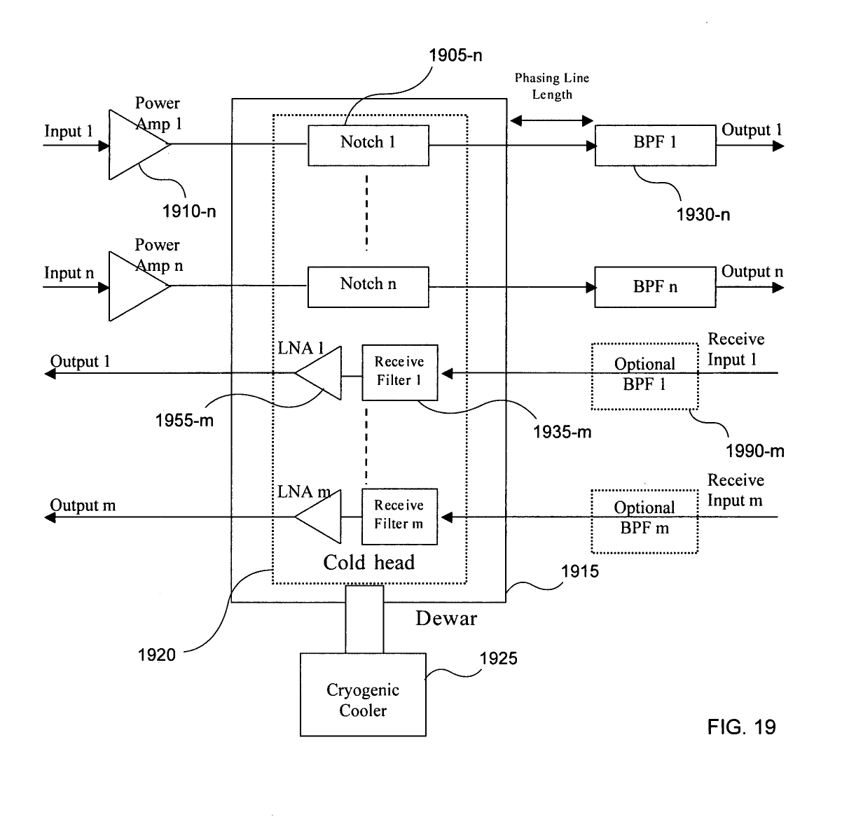

Referring now to FIG. 19 a configuration shown including a combination of receive filters and transmit filters within the same cooling chamber 1915, according to one exemplary embodiment of the present invention. In this embodiment, a plurality of transmit HTS notch filters 1905-n, receiver HTS filters 1935-n, and LNAs 1955-m may be included inside a cooling chamber 1915, for example a dewar. The transmit HTS notch filters 1905-n, receiver HTS filters 1935-m, and LNAs 1955-m may be coupled to or mounted on a cold head 1920. The notch filters 1905-n may be coupled to transmitter power amplifiers 1910-n and band pass filters 1930-n. The receiver filters 1935-m may be coupled at their inputs to respective receiver band pass filters (optional). There may be the same number of transmit and receive channels (i.e. n=m), or there may be a different number of channels (i.e. n≠m).

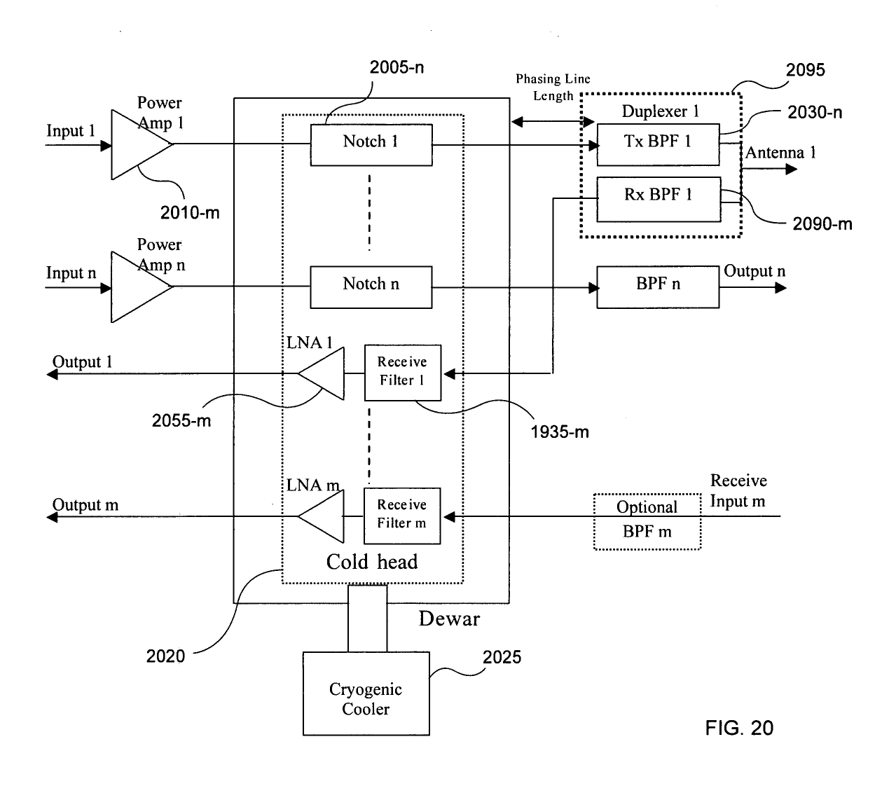

Referring now to FIG. 20 a configuration is shown including a combination of receive filters and transmit filters within the same cooler, according to one exemplary embodiment of the present invention. This embodiment is similar to the embodiment shown in FIG. 19 but includes the variation of combining a transmit band pass filter 2030-n and a receive band pass filter 2090-m to form a duplexer 2095. The input filter on the receive channel is optional and may be combined with the transmit filter to form a duplexer (as shown on channel 1). There may be the same number of transmit and receive channels (i.e. n=m), or there may be a different number of channels (i.e. n≠m).

The use of cryogenic, high Q, band reject resonators according to various embodiments of the present invention are resonant outside of the operating band to create very sharp rejection close to the band edge. Various embodiments minimize the stored energy in the cryogenic resonators by resonating outside of the operating band. This minimizes the stored energy in the resonators enabling applications requiring high power handling. Further, various embodiments combine the cryogenic band reject resonators to form a band reject filter that adds to the rejection characteristics of a conventional normal temperature band pass filter. Finally, various embodiments may reduced the complexity and cost of a power amplifier due to the rejection of out-of-band noise power by the filter rather than the use of analog or digital techniques in the power amplifier to achieve noise reduction.

Other aspects and embodiments of the present invention will be apparent to those skilled in the art from consideration of the specification and practice of the invention disclosed herein. For example, the filter networks may be applicable to any communication system and the communication system may be, for example, a hybrid system including fiber optics. In addition, those skilled in the art will appreciate that the invention is not restricted to frequency bands used in the AMPS standard, and may, in principle, operate in other frequency bands used in other mobile phone standards, wireless applications, and other communication systems. It is intended that the specification and illustrated embodiments be considered as exemplary only, with a true scope and spirit of the invention being indicated by the following claims. While embodiments of the invention have been described above, it is evident that many alternatives, modifications and variations will be apparent to those skilled in the art. Accordingly, the embodiments of the invention, as set forth above, are intended to be illustrative, and should not be construed as limitations on the scope of the invention. Various changes may be made without departing from the spirit and scope of the invention. Accordingly, the scope of the present invention should be determined not by the embodiments illustrated above, but by the claims appended hereto and their legal equivalents.

1. A communication system comprising:
a transmit filter network including a first non-superconducting filter and a first superconductor filter couple together.

2. The communication system of claim 1, wherein the first superconductor filter is a notch filter or a band reject filter.

3. The communication system of claim 2, wherein the first non-superconductor conductor filter is a band pass filter.

4. The communication system of claim 3, further comprising a receive filter network including a second non-superconducting filter and a second superconductor conductor filter coupled together.

5. The communication system of claim 4, wherein the transmit filter network further comprises a second superconductor filter coupled to the first non-superconducting filter and the first superconductor conductor filter.

6. The communication system of claim 1, wherein the transmit filter network further comprises a second superconductor filter coupled to the first non-superconducting filter and the first superconductor conductor filter.

7. The communication system of claim 1, wherein the first superconductor filter includes one or more high temperature superconductor components that are cryogenically cooled.

8. The communication system of claim 1, wherein the communication system is a wireless communication system and the transmit filter network is included in a base station transmitter.

9. A signal filter network comprising:
a transmit filter network including a first non-superconducting filter and a first superconductor filter couple together.

10. The signal filter network of claim 9, wherein the first superconductor filter is a notch filter or a band reject filter.

11. The signal filter network of claim 10, wherein the first non-superconductor conductor filter is a band pass filter.

12. The signal filter network of claim 11, further comprising a receive filter network including a second non-superconducting filter and a second superconductor conductor filter coupled together.

13. The signal filter network of claim 12, wherein the transmit filter network further comprises a second superconductor filter coupled to the first non-superconducting filter and the first superconductor conductor filter.

14. The signal filter network of claim 9, wherein the transmit filter network further comprises a second superconductor filter coupled to the first non-superconducting filter and the first superconductor conductor filter.

15. The signal filter network of claim 9, wherein the first superconductor filter includes one or more high temperature superconductor components that are cryogenically cooled.

16. The signal filter network of claim-9, wherein the signal filter network is included in a wireless communication system having a base station and the transmit filter network is included in a base station transmitter.

17. The signal filter network of claim 13, wherein the signal filter network is included in a wireless communication system having a base station and the transmit filter network is included in a base station transmitter and the receive filter network is included in a base station receiver.

18. A method of filtering transmission signals, comprising the steps of: filtering a transmit signal using one or more superconducting filter(s); and filtering the transmit signals using one or more non-superconducting filter(s).

19. The method of claim 18, wherein the step of filtering the transmit signal using the one or more superconducting filter(s) further comprises the step of filtering the transmit signal with one or more notch filter(s) or one or more band reject filter(s).

20. The method of claim 19, wherein the step of filtering the transmit signals using the one or more non-superconducting filter(s) further comprises the step of filtering the transmit signal with one or more band pass filter(s).
